(19) United States
(12) Patent Application Publication
(10) Pub. No.: US 2007/0149179 A1
(43) Pub. Date: Jun. 28, 2007

(54) Communication terminal allowing placing restrictions on disclosure of information, method implemented by communication terminal of placing restrictions on disclosure of information, and program therefor

(76) Inventor: Kazuyuki Kashiwabara, Hiroshima (JP)

Correspondence Address: WENDEROTH, LIND & PONACK L.L.P., 2033 K. STREET, NW, SUITE 800, WASHINGTON, DC, 20006, US

(21) Appl. No.: 10/582,225

(22) PCT Filed: Jun. 2, 2005
(86) PCT No.: PCT/JP05/10544

§ 371 Date: Jun. 8, 2006

(30) Foreign Application Priority Data
Jun. 3, 2004 (JP) 2004-166125

(51) Int. Cl. H04M 3/42

(52) U.S. Cl. 455/415; 379/246; 379/88.13; 455/412.1; 709/206

(57) ABSTRACT

There is provided a communication terminal for preventing an owner of a destination communication terminal from divulging personal information to a third party. When an owner of a communication terminal (11) passes to a destination communication terminal (12) his or her personal information on which he or she desires to place disclosure restrictions, a presentation attribute which is set to “not permitting presentation” is transmitted together with the personal information. When the destination communication terminal (12) passes the personal information of the communication terminal (11) to another communication terminal, the presentation attribute of the personal information of the communication terminal (11) is checked in the destination communication terminal (12). If the presentation attribute is set to “not permitting presentation”, the destination communication terminal (12) prevents itself from transmitting the personal information to the other communication terminal.

### TECHNICAL FIELD

The present invention relates to a communication terminal having a security function which places restrictions on disclosure of personal information, such as a telephone number, an electronic mail address, etc., which has been obtained from a communication partner, a method of placing restrictions on disclosure by the communication terminal of information, and a program for implementing the method.

### BACKGROUND ART

As is well known, a fixed telephone, a mobile telephone, a PHS, etc., have a telephone directory function which achieves entering and holding of personal information such as a name, a telephone number, etc., with respect to a plurality of individuals. If this telephone directory function is employed, when answering a telephone call, it is possible to recognize a call originator by viewing a displayed screen if the personal information of the call originator has been previously entered, and when placing a telephone call, it is possible to easily place the telephone call by selecting a name of a communication partner from a telephone directory, without having to input a telephone number. Needless to say, entering of personal information in the telephone directory can be easily performed by utilizing a reception history which is recorded when a telephone call is received from a call originator whose personal information has not been entered in the telephone directory.

However, personal information entered in the telephone directory or information of the telephone number of a call originator recorded in the reception history is no longer under the management of that individual or the call originator, but can be used arbitrarily by a communication terminal of the communication partner. Thus, it may happen that a telephone number entered in a telephone directory or a telephone number recorded in a reception history is presented (i.e., divulged) by an owner of the destination communication terminal to a third party, regardless of the wishes of the owner of the telephone number, which may result in a disadvantage for the owner of the telephone number. Suppose, for example, that Mr. B is asked by Mr. C to tell him a telephone number of Mr. A. In this case, it is easy to retrieve the telephone number of Mr. A from a telephone directory and display the telephone number on a screen to show it to Mr. C.

Thus, as a method to solve such a problem, there has been proposed a method of providing a secret flag so as to be associated with personal information recorded in a telephone directory. In this method, secret flags are individually set for pieces of personal information which should not be displayed. If a telephone call is received from an individual for whom a secret flag is set, information which identifies the call originator, e.g., his or her telephone number, name, etc., is prevented from being displayed on a screen.

### DISCLOSURE OF THE INVENTION

In the above-described conventional solution, however, the secret flag is set by the owner of the destination communication terminal; therefore, it depends on the ethics of this owner whether information is divulged or not. In other words, there still remains a risk of the personal information being divulged from the owner of the destination communication terminal to a third party regardless of the wishes of the owner of the telephone number.

Therefore, an object of the present invention is to provide a communication terminal which allows an owner of a telephone number to place restrictions on disclosure of his or her personal information to prevent an owner of a destination communication terminal from divulging the personal information to a third party, and a method implemented by the communication terminal of placing restrictions on the disclosure of the information.

The present invention is directed to a communication terminal for communicating with another communication terminal via telephone or electronic mail. To achieve the object above, the communication terminal according to the present invention includes a communication section, a personal information storage section, a personal information determination section, and a personal information presentation section.

The communication section receives, from another communication terminal, personal information including at least a telephone number or electronic mail address of the other communication terminal and a presentation attribute that indicates whether presentation of the personal information to a third party is permitted. The personal information storage section stores the personal information and presentation attribute acquired from the other communication terminal received by the communication section. The personal information determination section determines whether presentation of the personal information stored in the personal information storage section to the third party is permitted based on the presentation attribute. The personal information presentation section presents, to the third party via the communication section, only personal information that has been determined by the personal information determination section to be permitted to be presented to the third party, the personal information having been acquired from the other communication terminal.

Preferably, the personal information determination section allows a display section included in the communication terminal to display the telephone number or electronic mail address acquired from the other communication terminal, only when the presentation attribute indicates that presentation is permitted.

Also, in the case where a presentation attribute of own personal information that has been passed to another communication terminal is further stored in the personal information storage section, when personal information of the other communication terminal is displayed, the presentation attribute of the own personal information that has been passed to the other communication terminal may be displayed together.

Further, in the case where the own personal information includes an expiration time of the own personal information, the communication terminal may further include a personal information update section operable to check whether the expiration time of the own personal information that has been passed to the other communication terminal has expired. Still further, in the case where the personal information acquired from the other communication terminal includes an expiration time of the personal information, the communication terminal may further include a personal information update section operable to place restrictions on placing a telephone call or transmitting an electronic mail by using the personal information acquired from the other communication terminal if the expiration time of the personal information has expired. In these cases, a user of the communication terminal may be notified that the expiration time of the own personal information has expired, which has previously been presented to the other communication terminal, or that the expiration time of the personal information acquired from the other communication terminal has expired and resulted in restrictions being placed on the personal information. Also, personal information whose expiration time has expired may be deleted from the personal information storage section.

Typically, the communication section transmits or receives the personal information and the presentation attribute by utilizing short-distance radio communication, without employing a radio communication network through which a telephone conversation is carried out or an electronic mail is transmitted or received. However, the communication section may transmit or receive the personal information and the presentation attribute by utilizing a radio communication network through which a telephone conversation is carried out or an electronic mail is transmitted or received.

The series of processes performed by the above-described communication terminal can be considered as a method for placing restrictions on disclosure of information. This method may be provided in the form of a program for causing a computer to execute this processing procedure. A computer-readable recording medium having this program recorded thereon may be introduced into a computer.

The present invention enables an owner of a telephone number to place restrictions on disclosure of his or her personal information. Therefore, divulge of the personal information from an owner of a destination communication terminal to a third party can be prevented. In addition, since short-distance radio communication is used for transmission and reception of personal information, it is possible to present the personal information securely after recognizing an individual to whom the personal information is to be presented. Further, since restrictions may be placed on display of personal information on a screen of a destination communication terminal, it is possible to surely prevent an owner of the destination communication terminal from divulging the personal information to a third party.

### BRIEF DESCRIPTION OF THE DRAWINGS

FIG. 1 is a schematic diagram of a communication system using a communication terminal according to a first embodiment.

FIG. 2 is a diagram illustrating a detailed structure of the communication terminal according to the first embodiment.

FIG. 3 is a flowchart illustrating a process for placing restrictions on disclosure of personal information performed by the communication terminal according to the first embodiment.

FIG. 4 is an exemplary personal information storage table held by a personal information storage section of the first embodiment.

FIG. 5 is a flowchart illustrating a process for placing restrictions on the disclosure of personal information performed by the communication terminal according to the first embodiment.

FIG. 6 is a diagram illustrating a detailed structure of a communication terminal according to a second embodiment.

FIG. 7 is a flowchart illustrating a process related to display of personal information performed by the communication terminal according to the second embodiment.

FIG. 8 is a flowchart illustrating a process related to display of personal information performed by the communication terminal according to the second embodiment.

FIG. 9 is a flowchart illustrating a process related to display of personal information performed by the communication terminal according to the second embodiment.

FIG. 10A is an exemplary screen displayed on a display section of the second embodiment.

FIG. 10B is an exemplary screen displayed on the display section of the second embodiment.

FIG. 10C is an exemplary screen displayed on the display section of the second embodiment.

FIG. 11 is a diagram illustrating a detailed structure of a communication terminal according to a third embodiment.

FIG. 12 is an exemplary personal information storage table held by a personal information storage section of the third embodiment.

FIG. 13 is an exemplary screen displayed on a display section of the third embodiment.

FIG. 14 is a flowchart illustrating a process related to display of personal information performed by the communication terminal according to the third embodiment.

FIG. 15 is a diagram illustrating a detailed structure of a communication terminal according to a fourth embodiment.

FIG. 16 is an exemplary personal information storage table held by a personal information storage section of the fourth embodiment.

FIG. 17 is a flowchart illustrating a process related to display of personal information performed by the communication terminal according to the fourth embodiment.

FIG. 18 is a schematic diagram of a communication system using a communication terminal according to a fifth embodiment.

FIG. 19 is a diagram illustrating a detailed structure of the communication terminal according to the fifth embodiment.

FIG. 20 is a flowchart illustrating a process related to display of personal information performed by the communication terminal according to the fifth embodiment.

FIG. 21 is a flowchart illustrating a process related to display of personal information performed by the communication terminal according to the fifth embodiment.

### BEST MODE FOR CARRYING OUT THE INVENTION

### First Embodiment

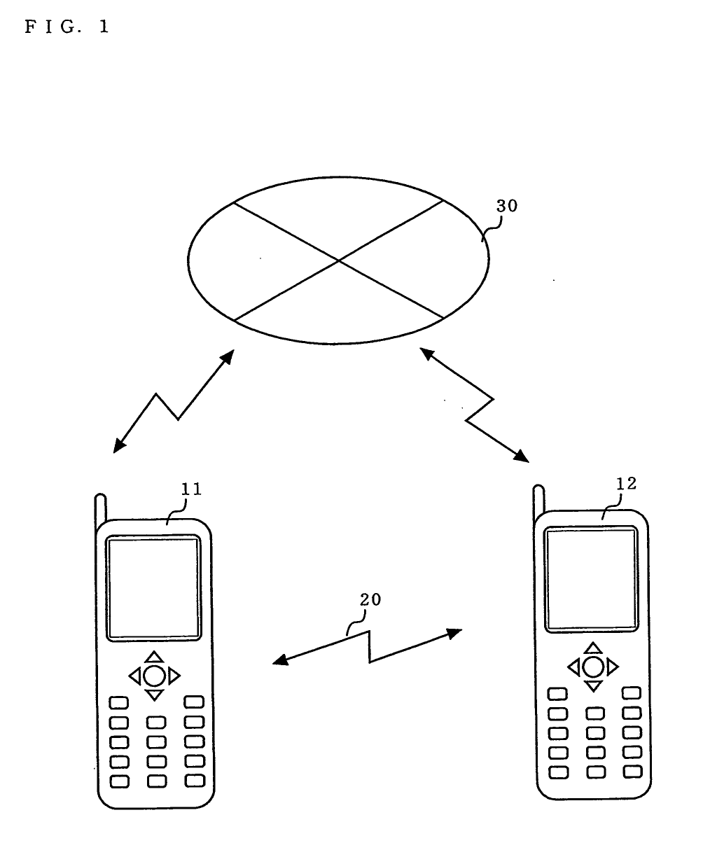

FIG. 1 is a schematic diagram of a communication system using a communication terminal according to a first embodiment of the present invention. In the communication system of FIG. 1, a communication terminal 11 and a communication terminal 12 are connected to each other via short-distance radio communication 20 using an infrared ray, Bluetooth®, etc., and via a radio communication network 30 using a radio wave. In the example of FIG. 1, both of the communication terminal 11 and the communication terminal 12 are mobile phones and have the same structure. In the following description, the communication terminal 11 and the communication terminal 12 are denoted as a mobile phone 11 and a mobile phone 12, respectively. In the short-distance radio communication 20, the mobile phone 11 and the mobile phone 12 exchange personal information and a presentation attribute therebetween. The personal information includes a telephone number, an electronic mail address, a name to be entered in a telephone directory, etc., and the presentation attribute is information indicating whether such personal information is permitted to be presented to a third party. In the radio communication network 30, the mobile phone 11 and the mobile phone 12 perform ordinary telephone communication therebetween. Note that FIG. 1 illustrates an exemplary case where the communication system includes two mobile phones, but the number of mobile phones may be greater than two.

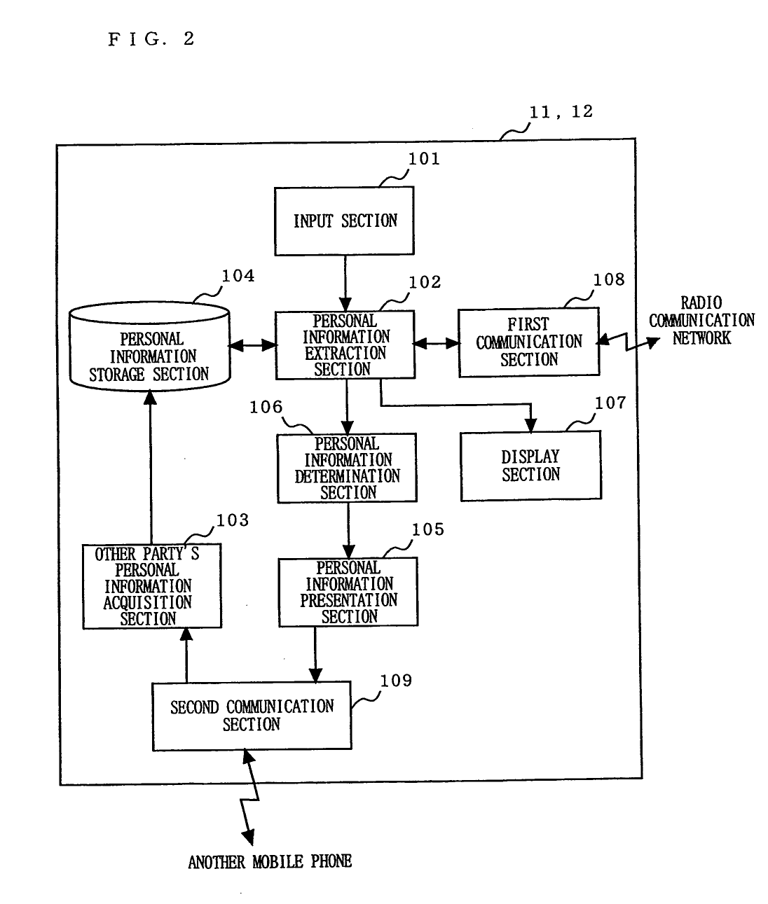

FIG. 2 is a diagram illustrating a detailed structure of the mobile phone 11 and the mobile phone 12 according to the first embodiment of the present invention. In FIG. 2, the mobile phone 11 and the mobile phone 12 each include an input section 101, a personal information extraction section 102, an other party's personal information acquisition section 103, a personal information storage section 104, a personal information presentation section 105, a personal information determination section 106, a display section 107, a first communication section 108, and a second communication section 109.

The input section 101 is an input button (e.g., ten keys), and is used for inputting personal information or various instructions such as placing or answering a telephone call, etc. The personal information extraction section 102 extracts, based on an instruction from an owner of the associated mobile phone, personal information of the associated mobile phone, which has been inputted via the input section 101, and/or personal information acquired from another mobile phone stored in the personal information storage section 104. With respect to pieces of personal information extracted by the personal information extraction section 102, the personal information determination section 106 refers to the presentation attribute of the personal information to determine whether the personal information acquired from another mobile phone is permitted to be presented to a third party on an individual basis. The personal information presentation section 105 transmits to the third party only a piece of personal information which has been determined by the personal information determination section 106 to be permitted to be presented to the third party, via the second communication section 109. The second communication section 109 performs exchanging of the personal information and the presentation attribute with another mobile phone, by utilizing the short-distance radio communication 20. Specifically, telephone directory exchange and business card exchange using IrDa communication are performed by utilizing the short-distance radio communication 20, for example. The other party's personal information acquisition section 103 acquires the personal information and the presentation attribute from the other mobile phone via the second communication section 109, and stores them in the personal information storage section 104. The display section 107 performs necessary display with respect to the personal information extracted by the personal information extraction section 102. The first communication section 108 performs, based on the personal information extracted by the personal information extraction section 102, telephone communication or mail exchange with another mobile phone, by utilizing the radio communication network 30.

Next, a process for placing restrictions on disclosure of the personal information performed by the mobile phone 11 and the mobile phone 12, which have the above structure, is described in regular order. The following explanation is made with respect to an exemplary case where the mobile phone 11 passes the personal information to the mobile phone 12 and thereafter the mobile phone 12 attempts to present the personal information of the mobile phone 11 to a third party.

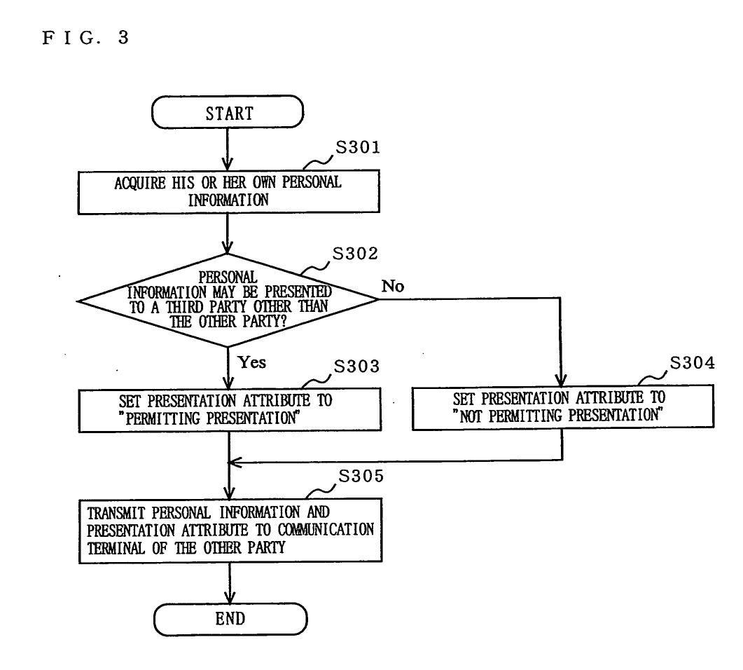

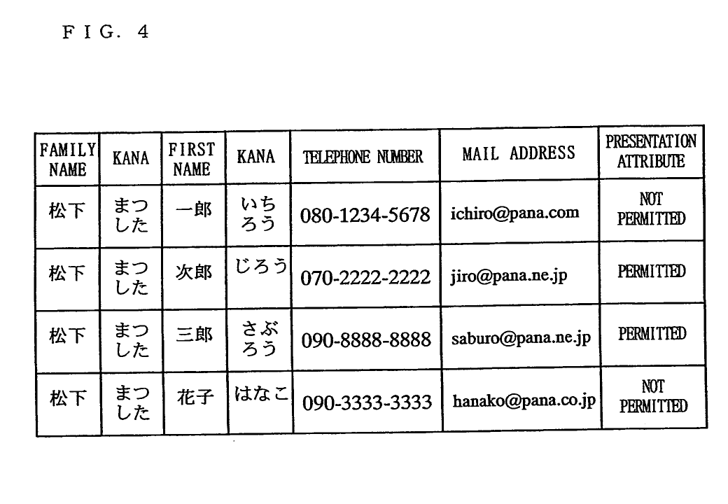

First, with reference to FIG. 3 and FIG. 4, a process to be performed by the mobile phone 11 when the mobile phone 11 passes the personal information to the mobile phone 12 is described.

When the owner of the mobile phone 11 passes his or her personal information (a telephone number, an electronic mail address, a name, etc.) to the mobile phone 12, the owner determines whether or not to place restrictions on the disclosure of the personal information. Specifically, placing restrictions on the disclosure of the personal information means that the disclosure of the personal information is limited only to an owner of the mobile phone 12, whereas not placing restrictions on the disclosure of the personal information means that the disclosure of the personal information is not limited to the owner of the mobile phone 12. Then, the owner of the mobile phone 11 passes to the personal information determination section 106 his or her personal information as well as information as to whether or not the owner of the mobile phone 11 has determined to place restrictions on the disclosure of the personal information (step S301). Once receiving from the owner the personal information and the information as to whether or not the owner of the mobile phone 11 has determined to place restrictions on the disclosure of the personal information, the personal information determination section 106 determines whether the disclosure restrictions should be placed or not (step S302). Then, in the case where the disclosure restrictions should not be placed, the personal information determination section 106 sets the presentation attribute of the personal information to “permitting presentation” (step S303), and, in the case where the disclosure restrictions should be placed, the personal information determination section 106 sets the presentation attribute of the personal information to “not permitting presentation” (step S304). Once the setting of the presentation attribute is completed, the personal information presentation section 105 transmits the personal information and the presentation attribute to the mobile phone 12 via the second communication section 109 (step S305).

The mobile phone 12 receives the personal information and the presentation attribute transmitted from the mobile phone 11 with the other party's personal information acquisition section 103 via the second communication section 109. The other party's personal information acquisition section 103 stores the received personal information and the presentation attribute in the personal information storage section 104. FIG. 4 illustrates an exemplary personal information storage table held by the personal information storage section 104. As illustrated in FIG. 4, the personal information storage table stores the personal information and the presentation attribute as a pair for each one of the other mobile phones.

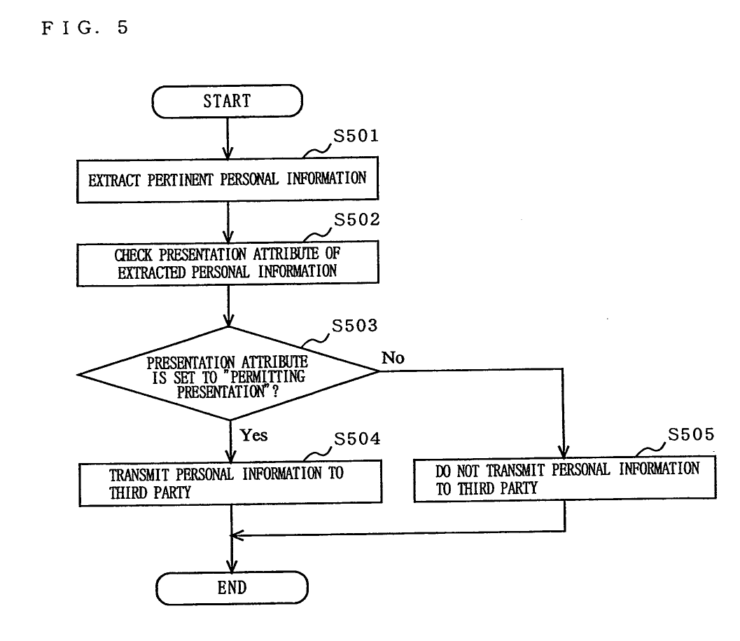

Next, with reference to FIG. 5, a process to be performed by the mobile phone 12 when the mobile phone 12 attempts to pass the personal information of the mobile phone 11 to another mobile phone is described.

In the case where it is intended that the personal information acquired from the mobile phone 11 be passed to a mobile phone possessed by a third party, the personal information extraction section 102 of the mobile phone 12 extracts a pertinent piece of personal information from the personal information storage section 104 (step S501). Next, the personal information determination section 106 checks the presentation attribute of the piece of personal information, and determines whether or not it is permitted to be presented (steps S502 and S503). In the case where the presentation attribute indicates “permitting presentation”, the personal information presentation section 105 sends the piece of personal information to the other mobile phone via the second communication section 109 (step S504). On the other hand, in the case where the presentation attribute indicates “not permitting presentation”, the personal information presentation section 105 does not send the piece of personal information to the other mobile phone (step S505).

As described above, with the communication terminal according to the first embodiment of the present invention, the owner of the telephone number of the communication terminal is capable of making the setting of the restrictions on the disclosure of his or her personal information. Therefore, he or she is able to prevent the owner of a destination communication terminal from divulging the personal information to a third party. Further, since the short-distance radio communication is used for transmitting and receiving the personal information, the personal information can be reliably presented to the other party after recognizing the other party.

### Second Embodiment

In the above-described first embodiment, sending of the personal information from the destination mobile phone to a third party is restricted to prevent the personal information from being divulged. However, it still remains possible that a telephone number, etc., is displayed on a display screen of the destination mobile phone freely. Therefore, there remains a risk of the personal information being divulged via this display screen.

Therefore, in a second embodiment, a communication terminal is described which is capable of placing restrictions on displaying the personal information on the display screen in accordance with the presentation attribute, thereby preventing the personal information from being divulged via the display screen.

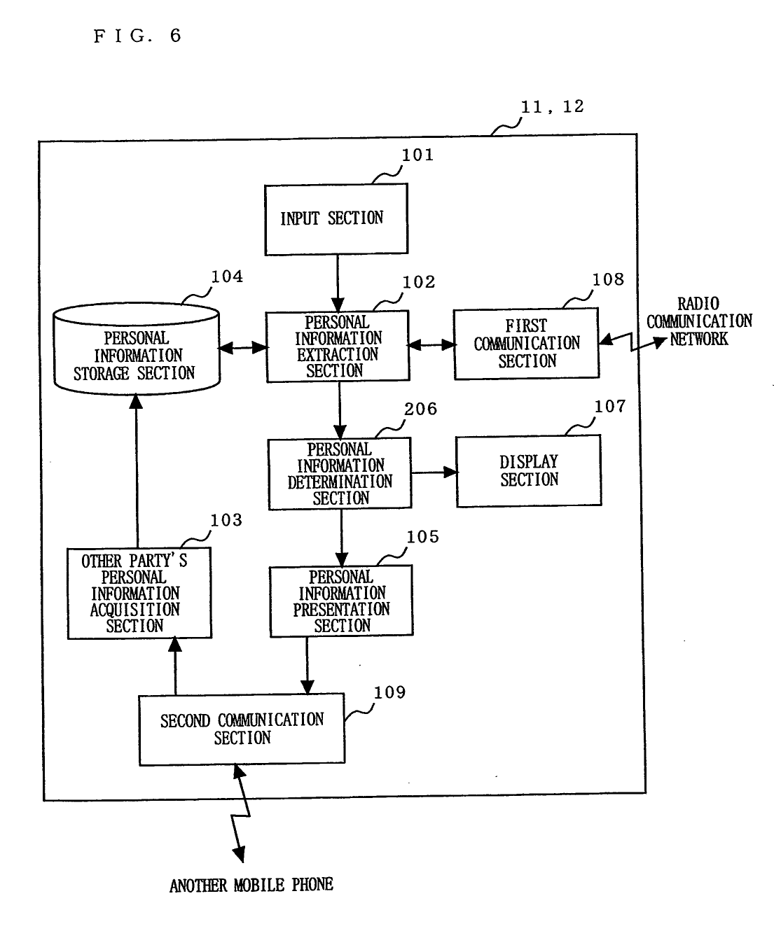

FIG. 6 is a diagram illustrating a detailed structure of the mobile phone 11 and the mobile phone 12 according to the second embodiment of the present invention. In FIG. 6, the mobile phone 11 and the mobile phone 12 each include the input section 101, the personal information extraction section 102, the other party's personal information acquisition section 103, the personal information storage section 104, the personal information presentation section 105, a personal information determination section 206, the display section 107, the first communication section 108, and the second communication section 109. As is seen from FIG. 6, the mobile phone 11 and the mobile phone 12 according to the second embodiment are different from the mobile phone 11 and the mobile phone 12 according to the first embodiment in the structure of the personal information determination section 206. Hereinafter, the second embodiment is described with focus on this alternative structure.

With respect to pieces of personal information extracted by the personal information extraction section 102, the personal information determination section 206 refers to the presentation attribute of the personal information to determine whether the personal information is permitted to be presented to a third party and whether the personal information is permitted to be displayed on a display screen of the display section 107 on an individual basis. It is preferable that the presentation attribute allow the following two types of settings to be made independently, i.e., the setting of whether a telephone number is permitted to be presented and the setting of whether an electronic mail address is permitted to be presented. The personal information presentation section 105 transmits to the third party via the second communication section 109 only a piece of personal information which has been determined by the personal information determination section 206 to be permitted to be presented to the third party. The display section 107 displays on the display screen only a piece of personal information which has been determined by the personal information determination section 206 to be permitted to be displayed.

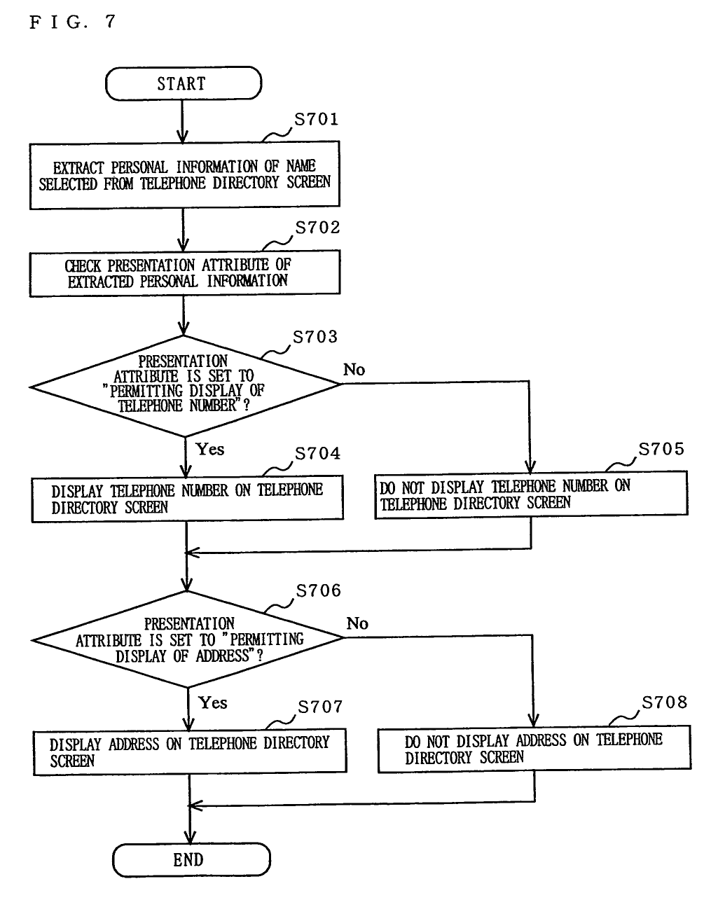

Hereinafter, with reference to FIG. 7 to FIG. 10, a process related to the display of the personal information, which is performed by the mobile phone 11 and the mobile phone 12 having the above-described structure, is described in regular order.

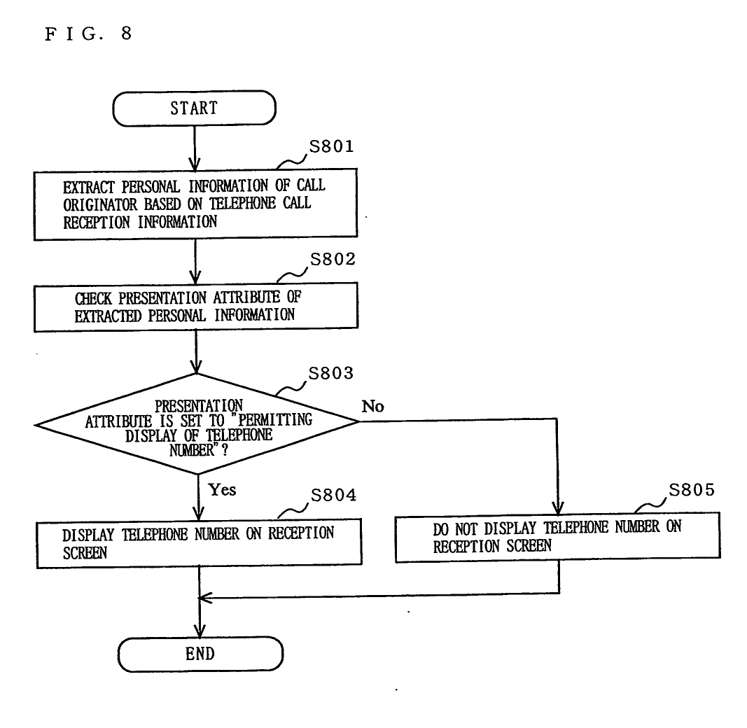

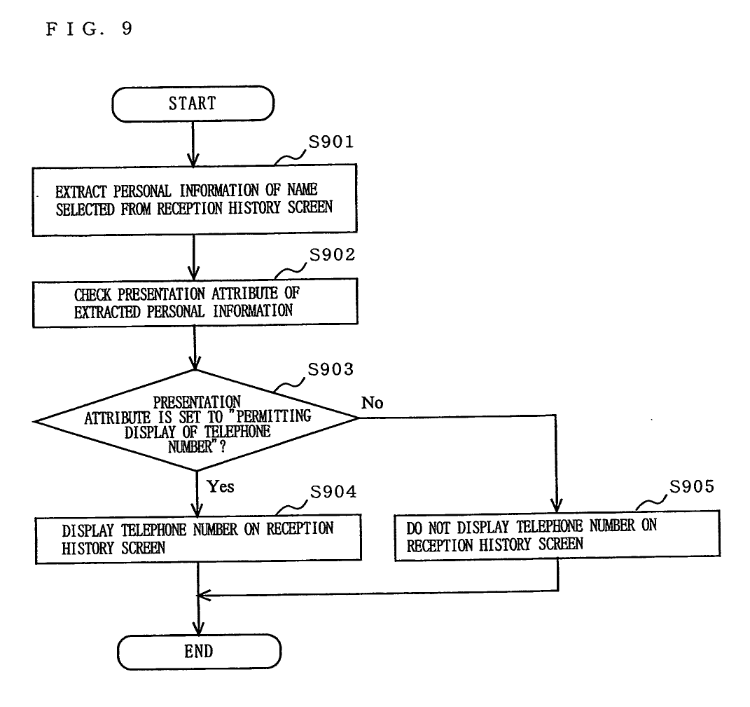

FIG. 7 is a flowchart illustrating a display process, which is performed when viewing the personal information by utilizing a telephone directory function. FIG. 8 is a flowchart illustrating a process of display the personal information, which is performed when receiving a telephone call or an electronic mail. FIG. 9 is a flowchart illustrating a display process, which is performed when viewing the personal information by utilizing a reception history function.

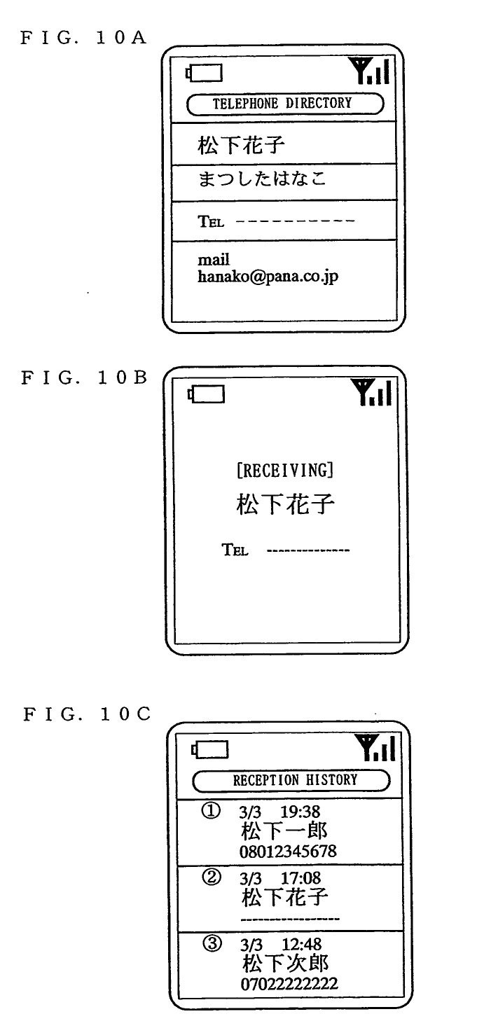

Referring to FIG. 7, once the owner of the mobile phone 12 selects an individual person (i.e., a name) by utilizing the telephone directory function, the personal information extraction section 102 extracts the personal information and the presentation attribute of the selected name from the personal information storage section 104 (step S701). Next, the personal information determination section 206 checks the presentation attribute of the personal information to determine whether the display of the telephone number is permitted (steps S702 and S703). The display section 107 either displays or does not display the telephone number on the display screen depending on the result of determination by the personal information determination section 206 (steps S704 and S705). In addition, the personal information determination section 206 checks the presentation attribute of the personal information to determine whether the display of the electronic mail address is permitted (step S706). The display section 107 either displays or does not display the electronic mail address on the display screen depending on the result of determination by the personal information determination section 206 (steps S707 and S708). FIG. 10A is an exemplary telephone directory screen displayed on the display section 107. Needless to say, control of whether or not to display personal information on a screen which is displayed when actually placing a telephone call by utilizing a telephone directory is also performed based on the presentation attribute of the personal information.

Referring to FIG. 8, once a telephone call or an electronic mail is received from the mobile phone 11, the personal information extraction section 102 extracts the personal information and the presentation attribute of the mobile phone 11 from the personal information storage section 104 (step S801). Next, the personal information determination section 206 checks the presentation attribute of the personal information to determine whether the display of the telephone number or the electronic mail address is permitted (steps S802 and S803). The display section 107 either displays or does not display the telephone number or the electronic mail address on the display screen depending on the result of determination by the personal information determination section 206 (steps S804 and S805). FIG. 10B is an exemplary reception-indicating screen displayed on the display section 707.

Referring to FIG. 9, once the owner of the mobile phone 12 starts utilizing the reception history function, the personal information extraction section 102 extracts a predetermined number of pieces of personal information and presentation attributes from the personal information storage section 104 (step S901). This predetermined number is, for example, the number of pieces of personal information that can be displayed on the display screen of the mobile phone 12 at one time. Next, the personal information determination section 206 checks the presentation attribute of each of the predetermined number of pieces of personal information to determine whether the display of the telephone number or the electronic mail address is permitted (steps S902 and S903). The display section 107 either displays or does not display the telephone number or the electronic mail address on the reception history screen depending on the result of determination by the personal information determination section 206 (steps S904 and S905). FIG. 10C is an exemplary reception history screen displayed on the display section 107.

As described above, the communication terminal according to the second embodiment of the present invention is capable of making the setting of the restrictions on the display of the personal information on the display screen of a destination communication terminal. Therefore, it is possible to surely prevent an owner of the destination communication terminal from divulging the personal information to a third party.

### Third Embodiment

In the above-described first and second embodiments, after the personal information and the presentation attribute are sent, it is not possible to check for whom presentation has been permitted and for whom presentation has been prohibited.

As such, in a third embodiment, a communication terminal is described which allows a provider of personal information to subsequently check for whom presentation has been permitted and for whom presentation has been prohibited.

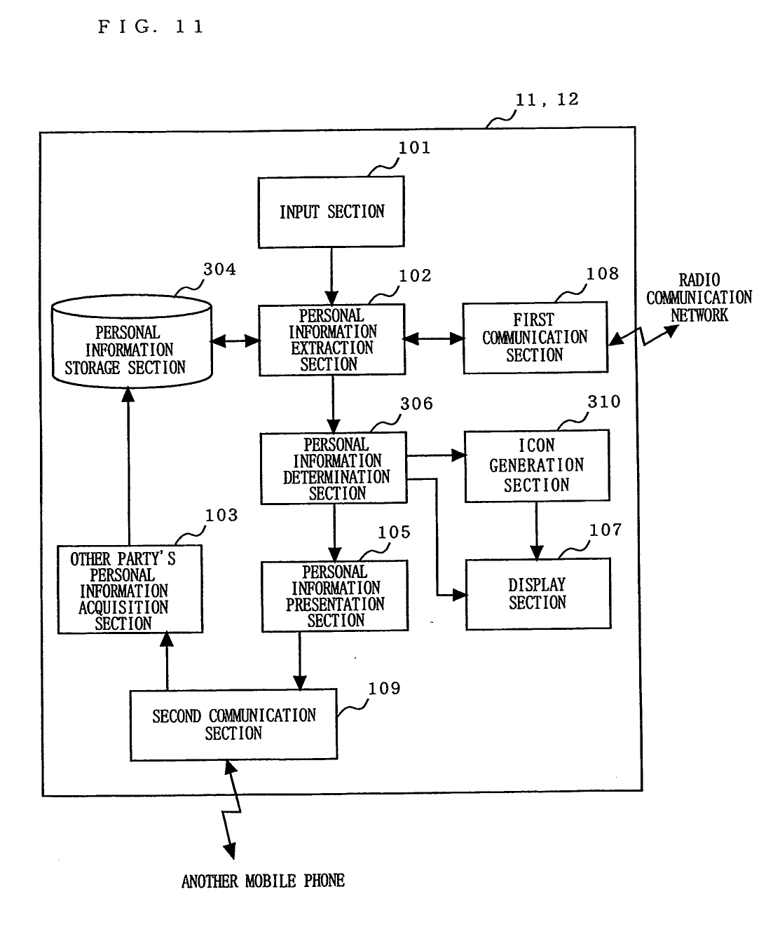

FIG. 11 is a diagram illustrating a detailed structure of the mobile phone 11 and the mobile phone 12 according to the third embodiment of the present invention. In FIG. 11, the mobile phone 11 and the mobile phone 12 each include the input section 101, the personal information extraction section 102, the other party's personal information acquisition section 103, a personal information storage section 304, the personal information presentation section 105, a personal information determination section 306, a icon generation section 310, the display section 107, the first communication section 108, and the second communication section 109. As is seen from FIG. 11, the mobile phone 11 and the mobile phone 12 according to the third embodiment are different from the mobile phone 11 and the mobile phone 12 according to the above-described first embodiment in the structures of the personal information storage section 304, the personal information determination section 306, and the icon generation section 310. Hereinafter, the third embodiment is described with focus on these alternative structures.

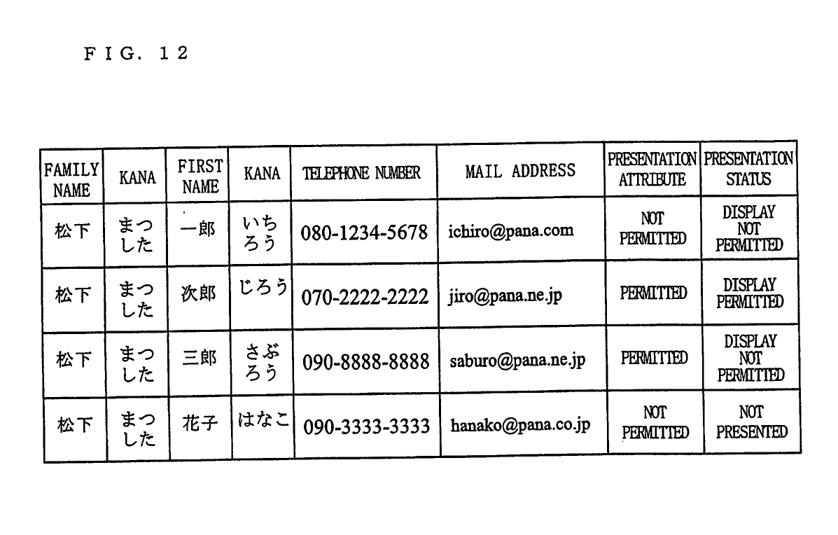

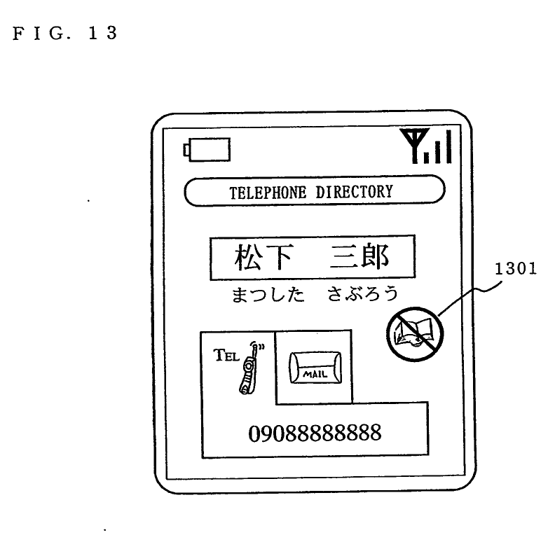

As illustrated in FIG. 12, the personal information storage section 304 has a personal information storage table which stores the personal information and the presentation attribute as a pair for each one of the other mobile phones, and which also stores a presentation status indicating the presentation attribute with which the personal information of the owner of the mobile phone has been sent to each one of the other mobile phones. The presentation status is stored by the personal information determination section 306. The icon generation section 310 stores an icon which is to be displayed when the presentation attribute indicates “not permitting presentation”, and an icon which is to be displayed when the presentation attribute indicates “permitting presentation”. The icon generation section 310 acquires from the personal information determination section 306 the status of the presentation attribute which has been transmitted to another mobile phone whose personal information is to be displayed on the display section 107, and provides to the display section 307 an icon corresponding to the status of the presentation attribute. The display section 107 displays only personal information which has been determined by the personal information determination section 306 to be permitted to be displayed along with the icon provided from the icon generation section 310. FIG. 13 is an exemplary telephone directory screen displaying a presentation prohibition icon 1301, the telephone directory screen being displayed on the display section 107.

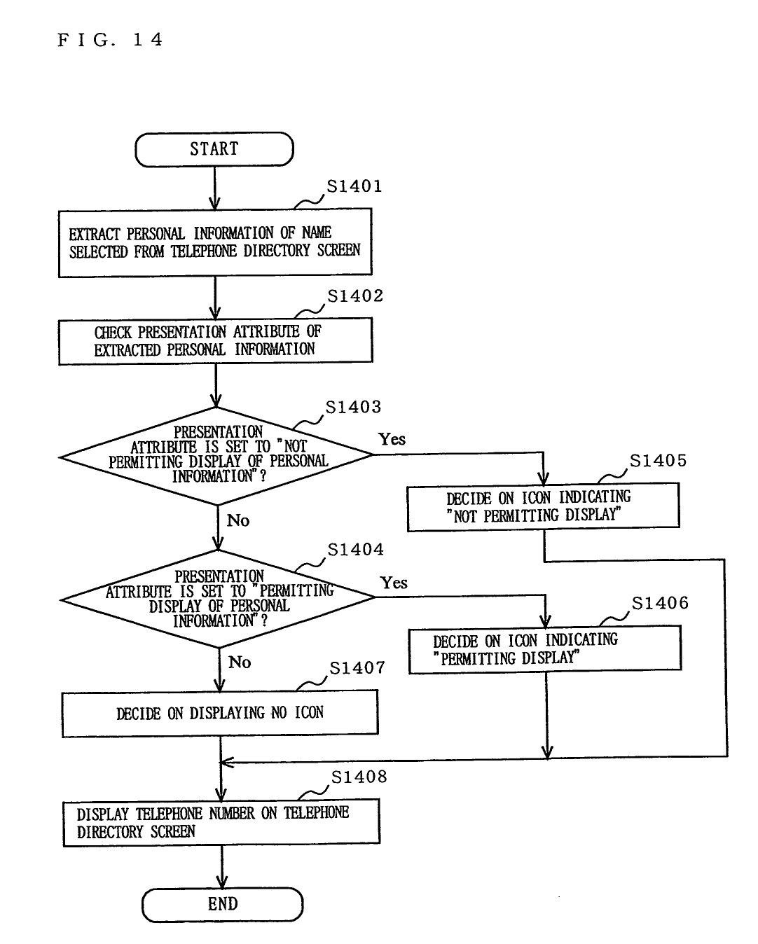

FIG. 14 is a flowchart illustrating a display process, which is performed when viewing the personal information by utilizing the telephone directory function. Once the owner of the mobile phone 12 selects an individual (a name) whose personal information the owner of the mobile phone 12 desires to view by utilizing the telephone directory function, the personal information extraction section 102 extracts from the personal information storage section 304 the personal information, the presentation attribute, and the presentation status of the selected name (step S1401). Next, the personal information determination section 306 checks the presentation attribute of the personal information to determine whether the telephone number is permitted to be presented (steps S1402 to S1404). The icon generation section 310 determines an icon to be displayed on the display section 107 in accordance with determination by the personal information determination section 306 (steps S1405 to S1407). The display section 107 either displays or does not display the telephone number on the display screen depending on the result of determination by the personal information determination section 306, while displaying the icon determined by the icon generation section 310 (step S1408).

As described above, with the communication terminal according to the third embodiment of the present invention, it is possible to know, by means of an icon, the status of the presentation attribute which has been transmitted to a destination communication terminal.

Note that the status of the presentation attribute may be arranged to be changeable by selecting an icon displayed on the display section 107, e.g., from “permitting presentation” to “not permitting presentation”, or from “not permitting presentation” to “permitting presentation”.

### Fourth Embodiment

In a fourth embodiment, a communication terminal is described which allows a presentation status of personal information to be changeable and have an expiration time.

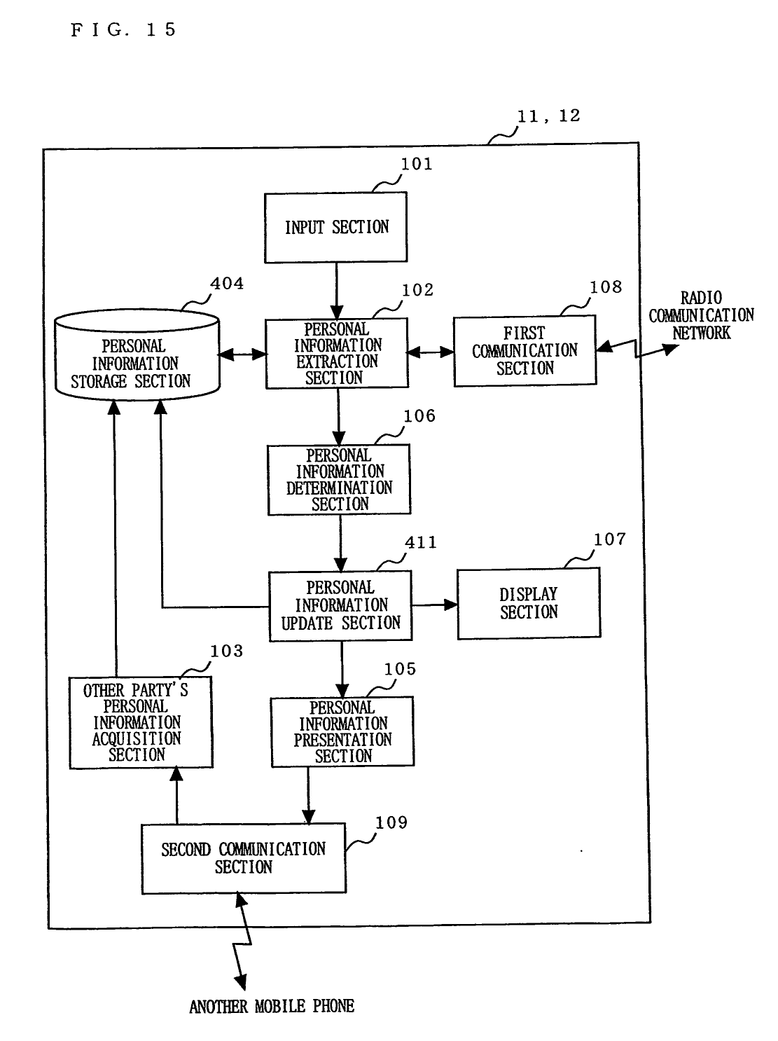

FIG. 15 is a diagram illustrating a detailed structure of the mobile phone 11 and the mobile phone 12 according to the fourth embodiment of the present invention. In FIG. 15, the mobile phone 11 and the mobile phone 12 each include the input section 101, the personal information extraction section 102, the other party's personal information acquisition section 103, a personal information storage section 404, the personal information presentation section 105, the personal information determination section 106, a personal information update section 411, the display section 107, the first communication section 108, and the second communication section 109. As is seen from FIG. 15, the mobile phone 11 and the mobile phone 12 according to the fourth embodiment are different from-the mobile phone 11 and the mobile phone 12 according to the first embodiment in the structures of the personal information storage section 404 and the personal information update section 411. Hereinafter, the fourth embodiment is described with focus on these alternative structures.

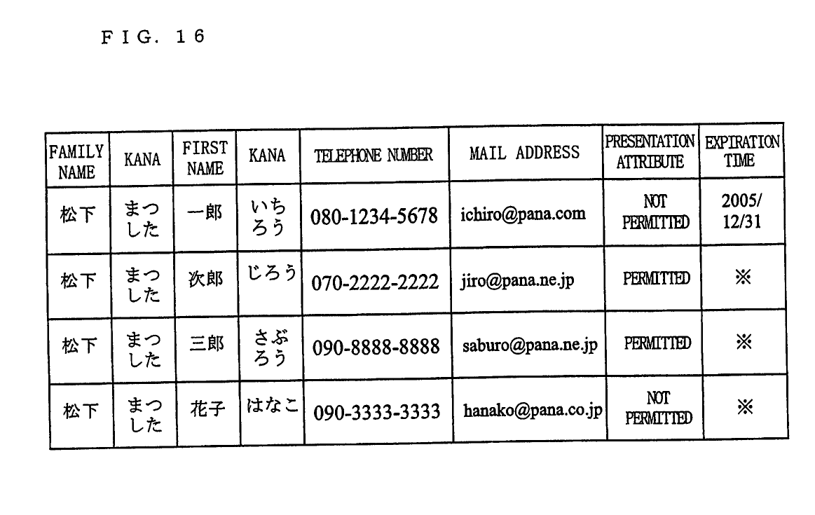

As illustrated in FIG. 16, the personal information storage section 404 has a personal information storage table that stores the personal information, the presentation attribute, and the expiration time as a set for each one of the other mobile phones. The expiration time is information which specifies a utilization status of the personal information and specifies, for example, whether or not presentation of the personal information is permitted, whether or not the personal information is permitted to be displayed, whether or not placement of a telephone call or sending of an electronic mail is to be prohibited, a complete deletion of the personal information from the mobile phone, or the like.

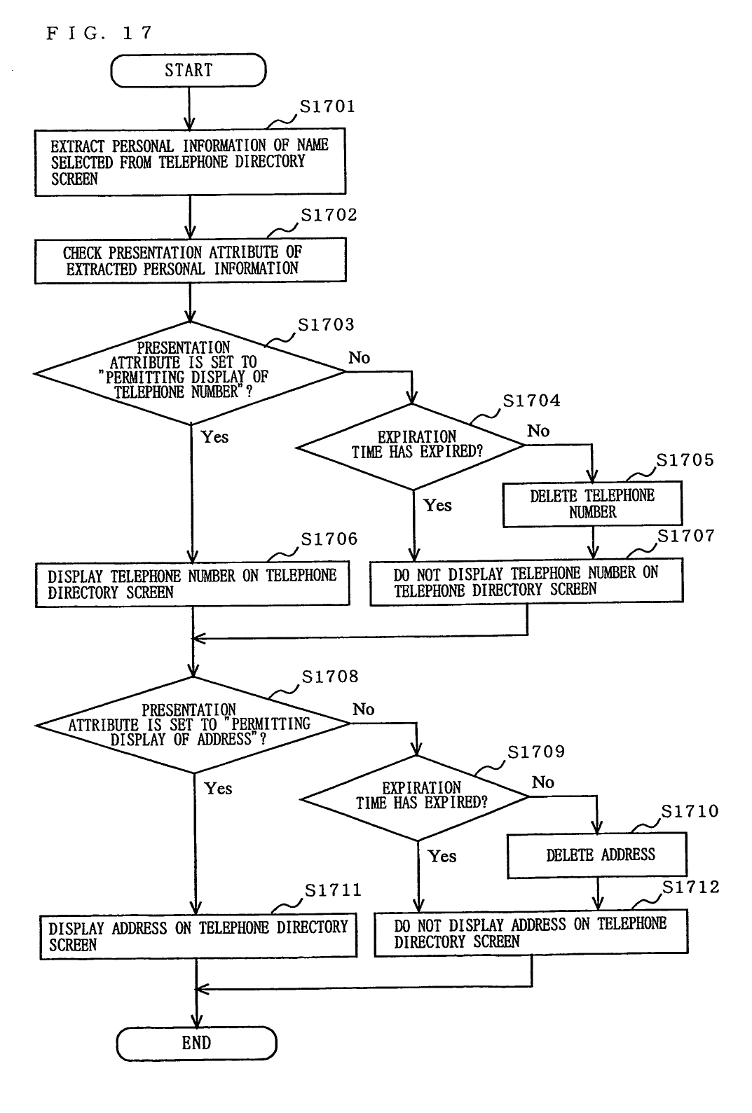

FIG. 17 is a flowchart illustrating a display process, which is performed when viewing the personal information by utilizing the telephone directory function. Once the owner of the mobile phone 12 selects an individual (i.e., name) whose personal information is desired to be viewed by utilizing the telephone directory function, the personal information extraction section 102 extracts from the personal information storage section 404 the personal information, presentation attribute, and expiration time of the selected name (step S1701). Next, the personal information determination section 106 checks the presentation attribute of the personal information to determine whether display of a telephone number is permitted (steps S1702 and S1703). The personal information update section 411 checks the expiration time (step S1704). The display section 107 either displays or does not display the telephone number on the screen and may delete the personal information, depending on the result of determination by the personal information determination section 106 and the check result by the personal information update section 411 (steps S1705 to S1707). The personal information determination section 106 checks the presentation attribute of the personal information to determine whether display of an electronic mail address is permitted (step S1708). The personal information update section 411 checks the expiration time (step S1709). The display section 107 either display or does not display the electronic mail address on the screen and may delete the personal information, depending on the result of determination by the personal information determination section 106 and the check result by the personal information update section 411 (steps S1710 to S1712). Note that, if it is determined at step S1704 or step S1709 that the expiration time has expired, it may be so arranged that the owner of the mobile phone be notified of the fact that the expiration time has expired.

As described above, since the communication terminal according to the fourth embodiment of the present invention sets an expiration time to completely delete personal information, the divulge of the personal information from the owner of a destination communication terminal to a third party is further prevented. Note that although the above-described fourth embodiment has illustrated an exemplary case where the control of whether or not to display a telephone number on a screen is performed or the deletion of personal information is performed as necessary, placement of a telephone call or transmission of an electronic mail may be controlled, instead.

### Fifth Embodiment

The above-described first to fourth embodiments have described the case where the personal information and the presentation attribute are exchanged between mobile phones. In a fifth embodiment, communication terminals are described which exchanges the personal information and the presentation attribute therebetween via a telephone directory server.

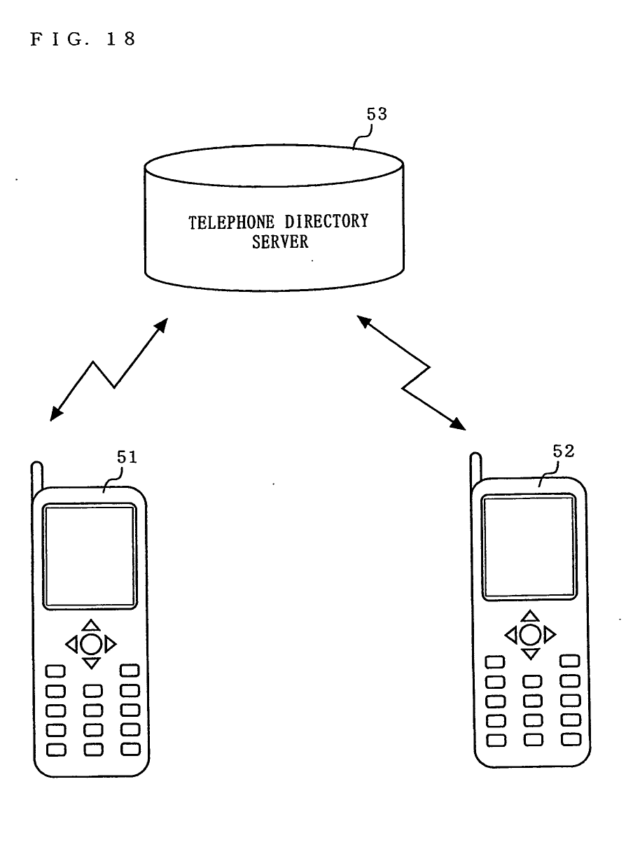

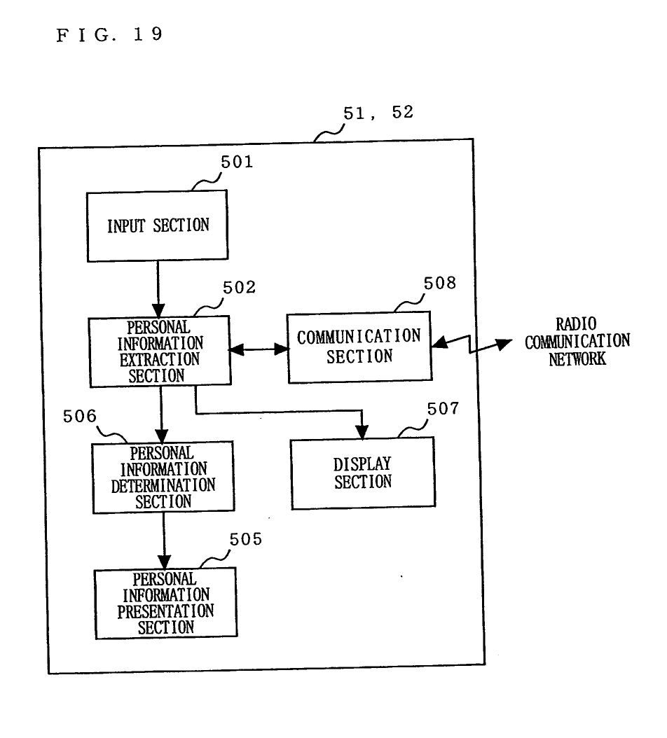

FIG. 18 is a schematic diagram of a communication system which uses a communication terminal according to a fifth embodiment of the present invention. The communication system of FIG. 18 is composed of a communication terminal 51, a communication terminal 52, and at least one telephone directory server 53. The communication terminal 51 and the communication terminal 52 are typically mobile phones. In the following description, the communication terminal 51 and the communication terminal 52 are denoted as a mobile phone 51 and a mobile phone 52. As illustrated in FIG. 19, the mobile phone 51 and the mobile phone 52 each include an input section 501, a personal information extraction section 502, a personal information presentation section 505, a personal information determination section 506, a display section 507, and a communication section 508. The telephone directory server 53 is a server which permits access on an individual basis, and in the example of FIG. 18, only the mobile phone 52 is granted permission to access.

The input section 501 is an input button such as ten keys or the like, and is used for inputting various instructions such as placing or answering a telephone call, etc. Based on an instruction from the owner of the mobile phone, the personal information extraction section 502 extracts personal information of another mobile phone stored in the telephone directory server 53 via the communication section 508. With respect to pieces of personal information extracted by the personal information extraction section 502, the personal information determination section 506 checks the presentation attribute of the personal information to determine whether the personal information is permitted to be presented to a third party on an individual basis. The personal information presentation section 505 allows the display section 507 to display only a piece of personal information that has been determined by the personal information determination section 506 to be permitted to be presented to a third party.

Next, a process of placing restrictions on disclosure of personal information, which is performed by the mobile phone 51 and the mobile phone 52 having the above structure, is described in regular order. The following explanation is made with respect to an exemplary case where the mobile phone 51 enters the personal information thereof in the telephone directory server 53 and thereafter the mobile phone 52 places a telephone call based on the personal information of the mobile phone 51 entered in the telephone directory server 53.

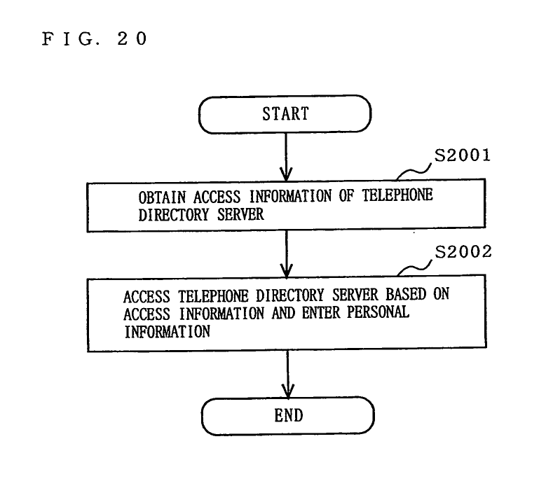

Referring to FIG. 20, when the mobile phone 51 enters its own personal information and presentation attribute in the telephone directory server 53, which is under the management of the mobile phone 52, the mobile phone 51 obtains access information of the telephone directory server 53 from the mobile phone 52 (step S2001). Then, the mobile phone 51 uses the obtained access information to access the telephone directory server 53, and enters the personal information and the presentation attribute therein (step S2002).

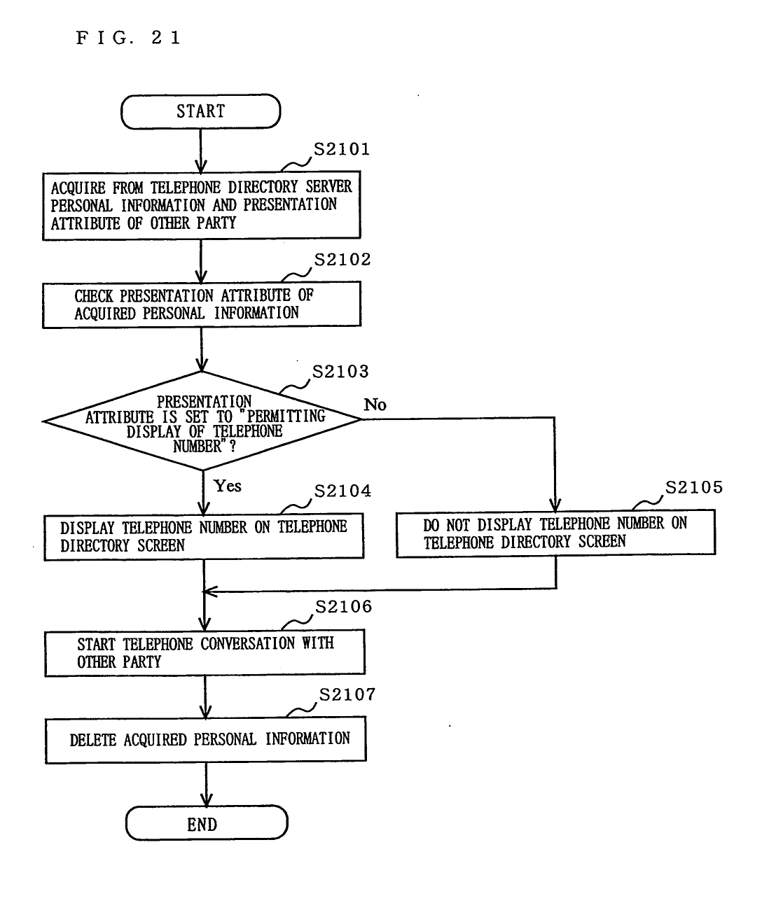

Referring to FIG. 21, when the mobile phone 52 places a telephone call (or sends an electronic mail) to the mobile phone 51, the personal information extraction section 502 of the mobile phone 52 accesses the telephone directory server 53 to acquire the personal information and presentation attribute of the mobile phone 51 (step S2101). Next, the personal information determination section 506 checks the presentation attribute of the personal information acquired by the personal information extraction section 502 to determine whether display of a telephone number is permitted (steps S2102 and S2103). The display section 507 either display or does not display the telephone number on a screen depending on the result of determination by the personal information determination section 506 (steps S2104 and S2105). Then, the personal information extraction section 502 starts a telephone conversation with the mobile phone 51, which corresponds to the acquired personal information (step S2106). Once the telephone conversation is finished, the personal information extraction section 502 deletes the acquired personal information and presentation attribute from the mobile phone 52 (step S2107).

As described above, in the communication terminal according to the fifth embodiment of the present invention, since the telephone directory server manages pieces of personal information collectively, divulge of personal information from a communication terminal to a third party can be completely prevented.

The above-described embodiments have described the case where personal information is passed to a recognizable individual by utilizing the short-distance radio communication 20. However, there are cases where the disclosure of personal information to a communication terminal at such a distance that an owner of the communication terminal is not recognizable is desired to be restricted. For example, such cases include a case where an owner of a communication terminal desires to place a call back to an unknown telephone number from which the owner has received a missed call while setting the presentation attribute to “not permitting display”, in order to avoid receiving a demand for payment from a wicked company.

In such a case, the presentation attribute may be sent via the radio communication network 30, through which a telephone conversation is carried out or an electronic mail is exchanged. Since the presentation attribute requires only one bit, it is easy to realize the presentation attribute by employing an undefined portion in a conventional radio communication protocol.

In order to prevent unintentional divulge of personal information, it is preferable that if no presentation attribute is set, the personal information be regarded as not being permitted to be presented. Also, the presentation attribute may be arranged to be freely changeable even after setting it once, which will lead to increased convenience.

In addition, the function as described above may be provided by a general-purpose program, independent of the communication terminal. Such a general-purpose program may be incorporated in various application programs with a little program alteration, so that such application programs can be sold to a developer or dealer of application software as software programs which achieve protection of personal information.

### INDUSTRIAL APPLICABILITY

The present invention is applicable to, e.g., a communication terminal having a telephone directory function which allows personal information, such as a name, a telephone number, etc., to be entered and held. In particular, the present invention is suitably used, for example, when restrictions should be placed on use of personal information, such as a telephone number, a mail address, etc., obtained from a communication partner.

1. A communication terminal for communicating with another communication terminal via telephone or electronic mail, the communication terminal comprising:
a communication section operable to receive, from another communication terminal, personal information including at least a telephone number or electronic mail address of the other communication terminal and a presentation attribute that indicates whether presentation of the personal information to a third party is permitted;
a personal information storage section operable to store the personal information and presentation attribute acquired from the other communication terminal received by the communication section;
a personal information determination section operable to determine whether presentation of the personal information stored in the personal information storage section to the third party is permitted based on the presentation attribute; and
a personal information presentation section operable to present, to the third party via the communication section, only personal information that has been determined by the personal information determination section to be permitted to be presented to the third party, the personal information having been acquired from the other communication terminal.

2. The communication terminal according to claim 1, wherein the personal information determination section allows a display section included in the communication terminal to display the telephone number or electronic mail address acquired from the other communication terminal, only when the presentation attribute indicates that presentation is permitted.

3. The communication terminal according to claim 1, wherein,
the personal information storage section is further operable to store a presentation attribute of own personal information that has been passed to another communication terminal, and
when personal information of the other communication terminal is displayed, the presentation attribute of the own personal information that has been passed to the other communication terminal is displayed together.

4. The communication terminal according to claim 3, wherein,
the own personal information includes an expiration time of the own personal information, and
the communication terminal further comprises a personal information update section which is operable to check whether the expiration time of the own personal information that has been passed to the other communication terminal has expired and is operable to notify a user of the communication terminal that the expiration time of the own personal information that has been passed to the other communication terminal has expired.

5. The communication terminal according to claim 1, wherein,
the personal information acquired from the other communication terminal includes an expiration time of the personal information, and
the communication terminal further comprises a personal information update section operable to place restrictions on placing a telephone call or transmitting an electronic mail by using the personal information acquired from the other communication terminal if the expiration time of the personal information has expired.

6. The communication terminal according to claim 5, wherein the personal information update section is operable to notify a user of the communication terminal that the expiration time of the personal information acquired from the other communication terminal has expired and resulted in restrictions being placed on the personal information.

7. The communication terminal according to claim 5, wherein the personal information update section is operable to delete, from the personal information storage section, personal information whose expiration time has expired.

8. The communication terminal according to claim 1, wherein the communication section transmits or receives the personal information and the presentation attribute by utilizing short-distance radio communication, without employing a radio communication network through which a telephone conversation is carried out or an electronic mail is transmitted or received.

9. The communication terminal according to claim 1, wherein the communication section transmits or receives the personal information and the presentation attribute by utilizing a radio communication network through which a telephone conversation is carried out or an electronic mail is transmitted or received.

10. A method for placing restrictions on disclosure of information employed by a communication terminal which communicates with another communication terminal via telephone or electronic mail, the method comprising the steps of:
receiving, from another communication terminal, personal information including at least a telephone number or electronic mail address of the other communication terminal and a presentation attribute that indicates whether presentation of the personal information to a third party is permitted;
storing the received personal information and presentation attribute acquired from the other communication terminal;
determining whether presentation of the stored personal information to the third party is permitted based on the presentation attribute; and
presenting to the third party only personal information that has been determined in the determining step to be permitted to be presented to the third party.

11. A program to be executed by a communication terminal which communicates with another communication terminal via telephone or electronic mail, for placing restrictions on disclosure of information, the program causing execution of the steps of:
receiving, from another communication terminal, personal information including at least a telephone number or electronic mail address of the other communication terminal and a presentation attribute that indicates whether presentation of the personal information to a third party is permitted;
storing the received personal information and presentation attribute acquired from the other communication terminal;
determining whether presentation of the stored personal information to the third party is permitted based on the presentation attribute; and
presenting to the third party only personal information that has been determined in the determining step to be permitted to be presented to the third party.

12. A recording medium having recorded thereon a program to be executed by a communication terminal which communicates with another communication terminal via telephone or electronic mail, the program causing execution of the steps of:
receiving, from another communication terminal, personal information including at least a telephone number or electronic mail address of the other communication terminal and a presentation attribute that indicates whether presentation of the personal information to a third party is permitted;
storing the received personal information and presentation attribute acquired from the other communication terminal;
determining whether presentation of the stored personal information to the third party is permitted based on the presentation attribute; and
presenting to the third party only personal information that has been determined in the determining step to be permitted to be presented to the third party.
